(19) United States
(12) Patent Application Publication
(10) Pub. No.: US 2024/0166343 A1
(43) Pub. Date: May 23, 2024

(54) Anti-Resonance System for Variable Speed Rotors

(71) Applicants: Ruthvik Chandrasekaran, Bristol, PA (US); Dewey H. Hodges, Atlanta, GA (US); David J. Hodges, Dallas, GA (US)

(72) Inventors: Ruthvik Chandrasekaran, Bristol, PA (US); Dewey H. Hodges, Atlanta, GA (US); David J. Hodges, Dallas, GA (US)

(21) Appl. No.: 18/514,175

(22) Filed: Nov. 20, 2023

Related U.S. Application Data
(60) Provisional application No. 63/427,180, filed on Nov. 22, 2022.

(51) Int. Cl. B64C 27/00

(52) U.S. Cl. CPC B64C 27/001; B64C 2027/004

(57) ABSTRACT

An anti-resonance system for a blade defining an elongated channel therein and affixed to a helicopter rotor includes a moveable mass disposed within the elongated channel of the blade so as to be able to slide along elongated channel. A moving device coupled to the moveable mass is configured to move the moveable mass within the elongated channel. A controller is configured to cause the moving device to move the moveable mass to a selected position within the elongated channel so as to avoid the additional resonance vibrations of the blade during a rotor speed change. In a method of avoiding resonance of a helicopter blade, a current rotational speed of the blade is determined. A position of the movable mass so as to avoid a resonance point at a current rotational speed is obtained. The moveable mass is moved to the position.

### CROSS-REFERENCE TO RELATED APPLICATION(S)

This application claims the benefit of U.S. Provisional Patent Application Ser. No. 63/427,180, filed Nov. 22, 2022, the entirety of which is hereby incorporated herein by reference.

### BACKGROUND OF THE INVENTION

### 1. Field of the Invention

The present invention relates to helicopter rotor blades and, more specifically, to a helicopter rotor blade that includes an anti-resonance system.

### 2. Description of the Related Art

The efficiency and operating envelope of rotorcraft are constrained by the speed of the rotor. Most helicopters operate at a constant rotor speed. Varying the speed of the rotor based on the operating condition could significantly improve the rotor's performance. However, changing the rotor speed leads to vibration issues when a rotor passes through a resonance point. The forces and moments acting on the blade and the hub increase significantly when a rotor passes through a resonance point.

Therefore, there is a need for a system that allows a rotor to avoid resonance points while varying rotor speed.

### SUMMARY OF THE INVENTION

The disadvantages of the prior art are overcome by the present invention which, in one aspect, is an anti-resonance system for a blade defining an elongated channel therein and affixed to a helicopter rotor that includes a moveable mass disposed within the elongated channel of the blade so as to be able to slide along elongated channel. A moving device coupled to the moveable mass is configured to move the moveable mass within the elongated channel. A controller is configured to cause the moving device to move the moveable mass to a selected position within the elongated channel so as to avoid the additional resonance vibrations of the blade during a rotor speed change.

In another aspect, the invention is a helicopter rotor assembly that includes a main rotor hub and a plurality of blades extending from the main rotor hub, each of which defining an elongated channel therein. A moveable mass is disposed within the elongated channel of each of the plurality of blades so as to be able to slide along elongated channel. A moving device is coupled to each moveable mass and is configured to move the moveable mass within the elongated channel. A controller is configured to cause each moving device to move the moveable mass to a selected position within the elongated channel so as to avoid resonance of each blade during rotor speed change. Changing a position of the moveable mass changes the blade's natural frequency, so that resonance points are actively moved out of rotor operating speed, thereby reducing blade vibrations.

In yet another aspect, the invention is a method of avoiding resonance of a helicopter blade, in which a current rotational speed of the blade is determined. A position of the movable mass so as to avoid a resonance point at a current rotational speed is obtained. The moveable mass is moved to the position.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a perspective view of a helicopter blade employing an anti-resonance system.

FIG. 1B is an exploded view of the system shown in FIG. 1A.

FIG. 1C is a top schematic view of the system shown in FIG. 1A.

FIG. 1D is a cross sectional view of the system shown in FIG. 1A taken along line 1D-1D.

FIG. 2 is a block diagram of a helicopter blade employing an anti-resonance system.

FIG. 3 is a schematic diagram showing a helicopter rotor assembly.

FIG. 4A is a graph showing rotor speed as it is changed smoothly.

FIG. 4B is a graph showing the moveable mass as it is moved towards the tip of the blade smoothly.

FIG. 4C is a graph showing the resonance point being moved out of the rotor operating range as the rotor speed is changed, in this example from 230 RPM to 180 RPM.

FIG. 4D is a graph showing the resonance vibrations bump as it disappears.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

The present blade design includes a moving mass system to actively move the resonance points of the blade. The sliding mass is located inside the blade and can travel along the length of the blade. The mass moves on a rail, which runs along the length and deforms with the blade. The mass is moved to a desired location using a mechanical control system. By changing the location of the mass along the length, the mass moment of inertia of the blade about the vertical axis is altered. Changing the mass moment of inertia of the blade changes the natural frequency of the blade. Varying the natural frequency, in turn, changes the resonance crossings. Hence, the system can actively change the location of its resonance points of the blade. The mass and location of the moving mass are selected and controlled to move the resonance points out of the rotor operating range.

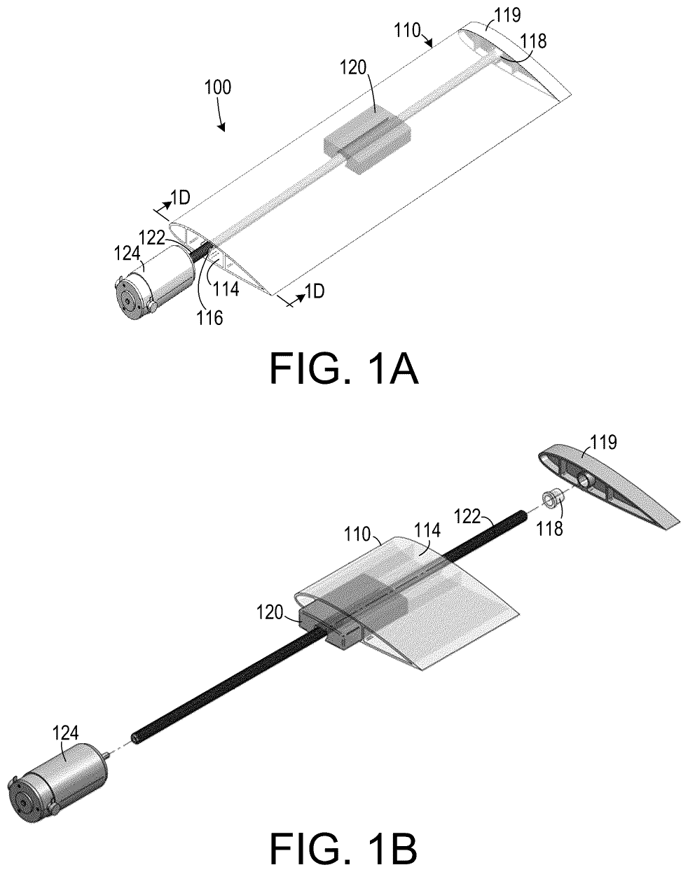

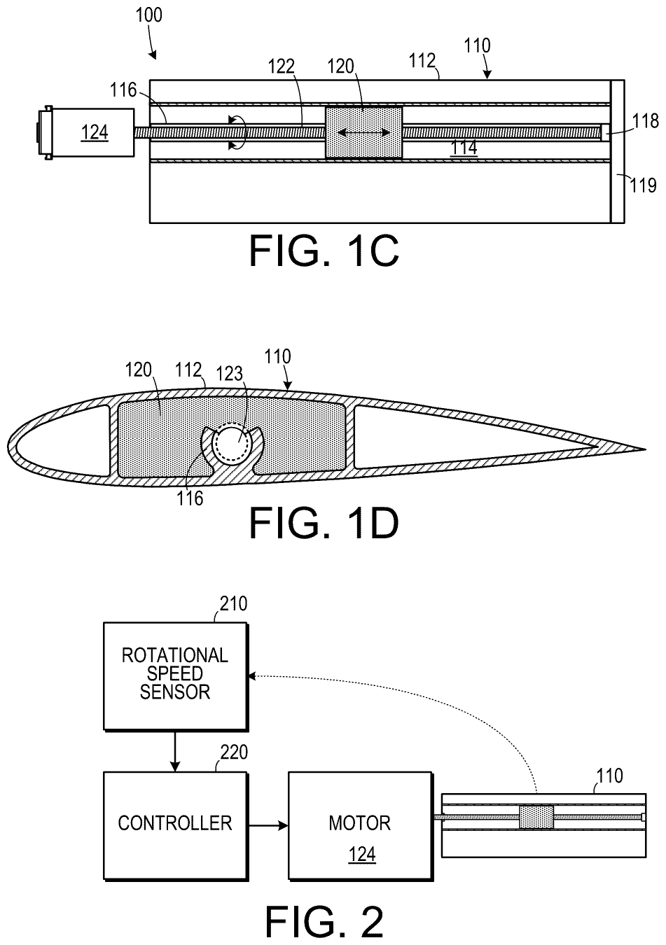

As shown in FIGS. 1A-1D and 2, one example of an anti-resonance system 100 for variable speed rotors includes a blade 110 that defines an elongated channel 114 therein that runs the length of the blade 110. A blade tip 119 encloses the channel 114 and provides structural support to the distal end of the blade 110. A moveable mass 120 is disposed in the channel 114 and slides along its length. A moving device is coupled to the moveable mass 120 and moves it to a desired position within the channel 114. A controller 220 causes the moving device to move the moveable mass 120 to a position that avoids the additional resonance vibrations of the blade 110 during a rotor speed change. Changing the position of the moveable mass changes the natural frequency of the blade 110 so that resonance points are moved actively out of rotor operating speed, which reduces blade vibrations.

The moving device can include an elongated force application structure that applies force to the moveable mass 120 and an actuator, which can be an electric motor 124, that is responsive to the controller 220. The motor 124 manipulates the elongated force application structure so as to cause the elongated force application structure to move the moveable mass 120 to the selected position. In one embodiment, the elongated force application structure comprises a threaded rod 122. The motor 124 is coupled to a first end of the threaded rod 122, which is supported by a cradle 116 that runs substantially along the length of the blade 110. The opposite end of the threaded rod 122 is supported by a bearing 118, which may be supported by the blade tip 119. The moveable mass 120 defines a threaded passage 123 that is complimentary in shape to the threaded rod 122, which is disposed in the threaded passage 123, so that rotation of the threaded rod 122 causes lateral movement of the moveable mass 120.

In this embodiment, a rotational speed sensor 210 provides a rotational speed input to the controller 220, which determines a position of the moveable mass 120 that will result in the resonance points of the blade 110 being moved out of the rotor operating range, thereby reducing vibrations in the blade 110. This can be done, for example, using a lookup table stored in the controller 220 or the selected position can be calculated by the controller 220. The motor 124 is responsive to a signal from the controller 220 and, as a result, it rotates the threaded rod 122 until the moveable mass 120 is in the desired selected position. The moveable mass 120 moves on a rail, which runs along the length of the blade 110 and deforms with the blade 110.

As a result of the movement of the moveable mass 120, the mass moment of inertia of the blade about the vertical axis can be altered. Changing the mass moment of inertia of the blade 110 changes the natural frequency of the blade 110. Varying the natural frequency, in turn, changes the resonance crossings. Hence, the blade 110 can actively change the location of its resonance points. If the mass and location of the moving mass 120 are correctly selected, it is possible to move the resonance point out of the rotor operating range.

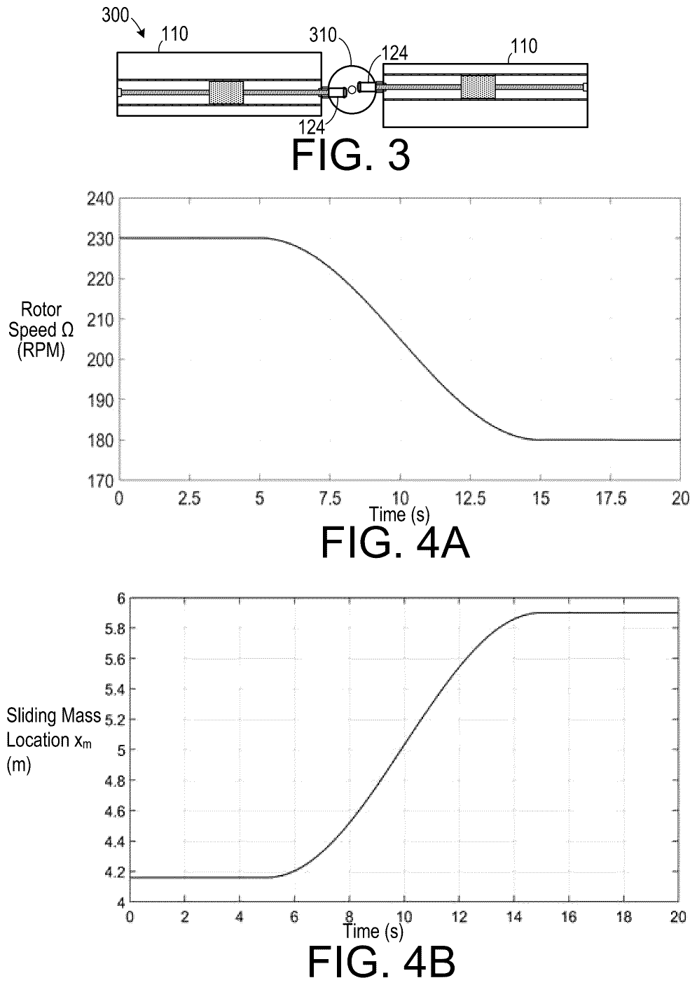

A helicopter rotor assembly 300 is shown in FIG. 3, in which a plurality of blades 110 are coupled to a main rotor hub 310, which is powered by the helicopter's engine. The motors 124 can be disposed in the main rotor hub 310, inside the blade or any of the structural components connecting the blade to the hub 310.

In one experimental embodiment, a cradle covers over 50% of the circumference of the threaded shaft so as to keep the shaft in place. The top of the threaded shaft is exposed to mate with the threads inside the movable mass. Nylon glide inserts are placed on the inside of the blade cross section to reduce friction and to prevent the movable mass from excessive vibration. The end of the threaded shaft opposite the drive motor is held into place by a bearing which is placed inside a bearing socket machined into the blade tip.

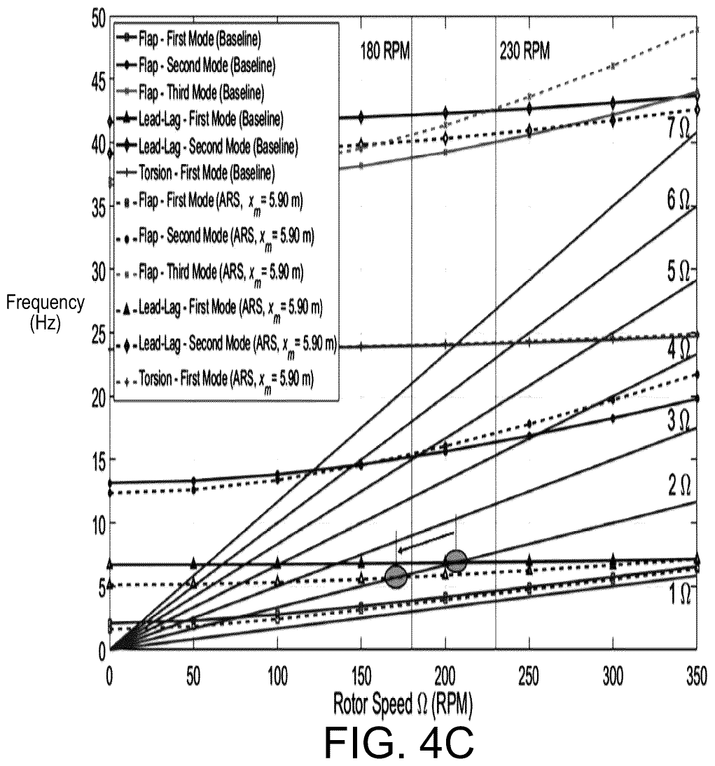

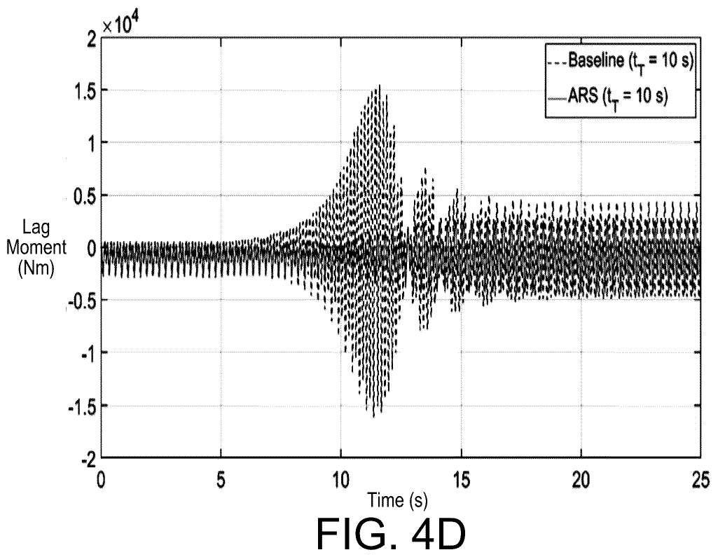

As shown in FIGS. 4A-4D, in this experimental embodiment, the moving mass was modeled as a point mass in DYMORE and the sliding motion was defined using the prismatic joint definition. The stiffness of the rail was assumed to be small compared to the blade and hence, neglected. The mass was assumed to be located on the beam's reference line. The mass properties of the blade were selected such that the first lag frequency remained close to the baseline blade. As the rotor speed was changed from 230 to 180 RPM in 10 seconds, the sliding mass was moved from 4.16 m to 5.90 m. As the mass was moved towards the tip, the natural frequency decreased. Therefore, the 2/rev lag resonance point located inside the rotor operating range was moved out of range. It was observed that the blade had no significant amplitude increase during this transition due to the absence of 2/rev resonance point and the amplitude of vibrations was decreased by almost 83% from the baseline blade

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. An anti-resonance system for a blade defining an elongated channel therein and affixed to a helicopter rotor, comprising:
(a) a moveable mass disposed within the elongated channel of the blade so as to be able to slide along elongated channel;
(b) a moving device coupled to the moveable mass and configured to move the moveable mass within the elongated channel; and
(c) a controller configured to cause the moving device to move the moveable mass to a selected position within the elongated channel so as to avoid the additional resonance vibrations of the blade during a rotor speed change.

2. The anti-resonance system of claim 1, wherein changing a position of the moveable mass changes the blade natural frequency, so as to move resonance points actively out of rotor operating speed, thereby reducing blade vibrations.

3. The anti-resonance system of claim 1, wherein the moving device comprises:
(a) an elongated force application structure that applies force to the moveable mass; and
(b) an actuator that is responsive to the controller and that manipulates the elongated force application structure so as to cause the elongated force application structure to move the moveable mass to the selected position.

4. The anti-resonance system of claim 3, wherein the elongated force application structure comprises a threaded rod and wherein the moveable mass defines a threaded passage that is complimentary in shape to the threaded rod, a portion of the threaded rod being disposed in the threaded passage.

5. The anti-resonance system of claim 4, wherein the threaded rod has a first end and an opposite second end and further comprising a cradle that supports the threaded rod from the first end and a bearing that supports the threaded rod at the second end.

6. The anti-resonance system of claim 5, wherein the actuator is coupled to the first end of the threaded rod.

7. The anti-resonance system of claim 3, wherein the actuator comprises an electric motor.

8. A helicopter rotor assembly, comprising:
(a) a main rotor hub;
(b) a plurality of blades extending from the main rotor hub, each of the plurality of blades defining an elongated channel therein;
(c) a moveable mass disposed within the elongated channel of each of the plurality of blades so as to be able to slide along elongated channel;
(d) a moving device coupled to each moveable mass and configured to move the moveable mass within the elongated channel; and
(e) a controller configured to cause each moving device to move the moveable mass to a selected position within the elongated channel so as to avoid resonance of each blade during rotor speed change,
wherein changing a position of the moveable mass changes the blade's natural frequency, so that resonance points are actively moved out of rotor operating speed, thereby reducing blade vibrations.

9. The helicopter rotor assembly of claim 8, wherein the moving device comprises:
(a) an elongated force application structure that applies force to the moveable mass; and
(b) an actuator that is responsive to the controller and that manipulates the elongated force application structure so as to cause the elongated force application structure to move the moveable mass to the selected position.

10. The helicopter rotor assembly of claim 9, wherein the elongated force application structure comprises a threaded rod and wherein the moveable mass defines a threaded passage that is complimentary in shape to the threaded rod, a portion of the threaded rod being disposed in the threaded passage.

11. The helicopter rotor assembly of claim 10, wherein the threaded rod has a first end and an opposite second end and further comprising a cradle that supports the threaded rod from the first end and a bearing that supports the threaded rod at the second end.

12. The helicopter rotor assembly of claim 11, wherein the actuator is coupled to the first end of the threaded rod.

13. The helicopter rotor assembly of claim 9, wherein the actuator comprises an electric motor.

14. A method of avoiding resonance of a helicopter blade, comprising the steps of:
(a) determining a current rotational speed of the blade;
(b) obtaining a position of the movable mass so as to avoid a resonance point at a current rotational speed; and
(c) moving the moveable mass to the position.

15. The method of claim 14, wherein the blade defines an elongated channel therein and further comprising the step of disposing the moveable mass within the elongated channel.

16. The method of claim 14, wherein the moveable mass defines a threaded passage through which a portion of an elongated threaded rod is disposed therein, the elongated threaded rod having threads that are complementary to the threaded passage, wherein the moving step comprises the step of rotating the elongated threaded rod.

17. The method of claim 16, wherein the rotating step comprises the step of actuating an electric motor that is coupled to a first end of the elongated threaded rod.

18. The method of claim 17, wherein the actuating step comprises the step of receiving, by the electric motor, a signal from a controller that is programmed to execute the calculating step.

19. The method of claim 16, wherein the helicopter blade has a first end and an opposite second end and further comprising the step of supporting the elongated threaded rod with a cradle adjacent to the first end of the helicopter blade and a bearing adjacent to the second end of the helicopter blade.
